(19) United States
(12) Patent Application Publication
(10) Pub. No.: US 2017/0280123 A1
(43) Pub. Date: Sep. 28, 2017

(54) METHOD AND DEVICE FOR DETECTING A SLICE TIME LENGTH IN A MEDIA PLAY LIST

(71) Applicants: Le Holdings(Beijing)Co., Ltd., Beijing (CN); LE SHI ZHI XIN ELECTRONIC TECHNOLOGY (TIAN JIN) LIMITED, Tianjin (CN)

(72) Inventor: Tao Wang, Tianjin (CN)

(21) Appl. No.: 15/242,482

(22) Filed: Aug. 19, 2016

Related U.S. Application Data
(63) Continuation of application No. PCT/CN2016/088977, filed on Jul. 6, 2016.

(30) Foreign Application Priority Data
Mar. 28, 2016 (CN) 201610184721.1

(51) Int. Cl. H04N 9/89

(52) U.S. Cl. CPC H04N 9/89

(57) ABSTRACT

Embodiments of the invention provide a method and device for detecting a slice time length in a media play list. The method includes: obtaining a slice time length of a specified slice in the media play list; determining whether the obtained slice time length satisfies a preset condition including lying within a preset range of time length and/or complying with a specified data format; and if not, then determining that the slice time length of the specified slice is abnormal.

### CROSS REFERENCE TO RELATED APPLICATIONS

This application is a continuation of International Application No. PCT/CN2016/088977, filed on Jul. 6, 2016, which is based upon and claims priority to Chinese Patent Application No. 201610184721.1, filed with the Chinese Patent Office on Mar. 28, 2016 and entitled “Method and device for detecting a slice time length in a media play list”, which is hereby incorporated by reference in its entirety.

### TECHNICAL FIELD

The disclosure relates to the field of information processing, and particularly to a method and device for detecting a slice time length in a media play list.

### BACKGROUND

A media file, e.g., a video file, has become information indispensable to our living and working. The existing media file includes a number of slices, and a media play list includes information describing slice time lengths (i.e., play time lengths) of the respective slices in the media file (for example, if the media play list is an m3u8 file, then there will be a #EXTINF field corresponding to each of the slices in the file, where the value of the field represents the slice time length of the corresponding slice).

The inventors have identified during making of the invention that the media file is typically played dependent upon the slice time lengths of the slices in the media file, and if there is an error in some slice time length, then the media file may not be played normally or may be interrupted. However there has been absent in the prior art of a technical solution to detect a slice time length for an error so that even if there is an error in some slice time length in the media file provided to a user, then the error may not be identified so that the media file will be transmitted as a normal media file to the user for playing, thus resulting in abnormal playing.

### SUMMARY

Embodiments of the invention provide a method and device for detecting a slice time length in a media play list so as to address the problem in the prior art of abnormal playing because there is no solution to detecting an error in a slice time length field.

Particular technical solutions according to the embodiments of the invention are as follows:

In an aspect, an embodiment of the invention provides a method for detecting a slice time length in a media play list, the method including:

obtaining a slice time length of a specified slice in the media play list;

determining whether the obtained slice time length satisfies a preset condition, the preset condition includes lying within a preset range of time length and/or complying with a specified data format; and

if not, then determining that the slice time length of the specified slice is abnormal.

In another aspect, an embodiment of the invention provides a device for detecting a slice time length in a media play list, the device including:

a memory configured to store various program and instructions;

a processor configured to execute the various program and instructions stored in the memory to perform the operations of:

obtaining a slice time length of a specified slice in the media play list; determining whether the obtained slice time length satisfies a preset condition, the preset condition comprises lying within a preset range of time length and/or complying with a specified data format; and if not, then determining that the slice time length of the specified slice is abnormal.

In another aspect, an embodiment of the invention provides a computer program, including computer readable codes that, when executed on a device, cause the device to perform:

obtaining a slice time length of a specified slice in the media play list;

determining whether the obtained slice time length satisfies a preset condition, the preset condition comprises lying within a preset range of a time length and/or complying with a specified data format; and

if not, then determining that the slice time length of the specified slice is abnormal.

An advantageous effect of the embodiments of the invention lies in that in the embodiments of the invention, the slice time length is detected for abnormality so that the user has knowledge of whether the slice time length in the media file is correct, and thus can take a corresponding countermeasure to correct the abnormal slice time length so as to improve the correctness of the slice time length of the slice being produced, thus lowering the probability that the media file may be played abnormally.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is an exemplary flow chart of a method for detecting a slice time length in a media play list in accordance with some embodiments.

FIG. 2 is a first schematic structural diagram of an device for detecting a slice time length in a media play list in accordance with some embodiments.

FIG. 3 is a second schematic structural diagram of an device for detecting a slice time length in a media play list in accordance with some embodiments.

FIG. 4 is a schematic structural diagram of a device for detecting a slice time length in a media play list in accordance with some embodiments.

### DETAILED DESCRIPTION

In order to make the objects, technical solutions, and advantages of the embodiments of the invention more apparent, the technical solutions according to the embodiments of the invention will be described below clearly and fully with reference to the drawings in the embodiments of the invention, and apparently the embodiments described below are only a part but not all of the embodiments of the invention. Based upon the embodiments here of the invention, all the other embodiments which can occur to those skilled in the art without any inventive effort shall fall into the scope of the invention.

### First Embodiment

As illustrated in FIG. 1, there is an exemplary flow chart of a method for detecting a slice time length in a media play list according to an embodiment of the invention, where the method includes the following steps:

The step 101 is to obtain a slice time length of a specified slice in the media play list.

In an embodiment, the media play list includes a correspondence relationship between slices and slice time length fields corresponding to the slices, so in the embodiment of the invention, the slice time length of the specified slice can be obtained according to the correspondence relationship.

The step 102 is to determine whether the obtained slice time length satisfies a preset condition, the preset condition includes lying within a preset range of time length and/or complying with a specified data format.

The step 103 is, if not, to determine that the slice time length of the specified slice is abnormal.

For the sake of further understanding, the solution according to the embodiment of the invention will be further described below particularly as follows:

I. In the step 102:

For example, the preset condition can be any one of:

(1) That the slice time length lies in a preset range of time length;

(2) That the slice time length complies with a specified data format; and

(3) That the slice time length lies in the preset range of time length, and complies with the specified data format.

Of course, it shall be noted that those skilled in the art can preset reasonably any preset condition for determining whether the slice time length is reasonable, according to a media file production specification as long as the condition is applicable to the embodiment of the invention, so the embodiment of the invention will not be limited thereto.

In an embodiment, in order to determine the preset range of time length, the preset range of time length can be determined in the following steps A1 and A2:

Step A1: obtaining at least one of reference values of ranges of time length, and the reference values of ranges of time length include the largest slice time length, the smallest slice time length, and the empirical value of the shortest slice time length recorded in the media play list, where the empirical value of the shortest slice time length is less than the largest slice time length and more than the smallest slice time length.

In an embodiment, the media play list further records that the largest slice time length represents the largest slice time length in the media file corresponding thereto, so the largest slice time length can be retrieved from the media play list. For example, the field #EXT-X-TARGETDURATION in the m3u8 file represents the largest slice time length.

In an embodiment, there is an upper limit for the Frame Per Second (FPS) of a slice, which is at most 60 FPS so far. Since there is at least one frame of data in each slice, the length of each frame is calculated as 1000 ms/60=16 ms given the largest frame per second of 60 FPS, so that the smallest slice time length shall be no less than 16 ms, and then the smallest slice time length can be 16 ms. Of course, if the upper limit of the frame per second is changed later, then the smallest slice time length may be changed. Moreover it shall be noted that a user can alternatively preset the smallest slice time length dependent upon the real frame per second of the slice, for example, if the real frame per second of the slice is A, then the smallest slice time length of the slice will be preset as a result of 1000 ms divided by A.

In an embodiment, the empirical value of the shortest slice time length can be derived as a function of the slice time length of a slice produced by existing dominating media file providers. For example, if the length of time of the majority of currently produced slices is no less than 1 second (1 s), then the empirical value of the shortest slice time length may be preset as 1 s; and if the length of time of the majority of currently produced slices is no less than 5 s, then the empirical value of the shortest slice time length may be preset as 5 s. In a particular implementation, the user can preset the empirical value of the shortest slice time length as needed under a real condition, so the embodiment of the invention will not be limited thereto.

Step A2: determining the preset range of time length as a function of the reference value of the range of time length.

The preset range of time length can include any one of:

1) Being no more than the largest slice time length;

2) Being no less than the smallest slice time length;

3) Being no less than an empirical value of the shortest slice time length;

4) Being no more than the largest slice time length, and no less than the smallest slice time length;

5) Being no more than the largest slice time length, and no less than the empirical value of the shortest slice time length;

6) Being no more than the largest slice time length, no less than the empirical value of the shortest slice time length, and no less than the smallest slice time length;

7) Being no less than the empirical value of the shortest slice time length, and no less than the smallest slice time length.

In an embodiment, there may be a different data format of a play time length in the media file play list in a different version, so in the embodiment of the invention, the specified data format can be determined in the following steps B1 to B4:

Step B1: obtaining a compatible version number of the media file play list.

The media file play list includes information about the compatible version number which can be retrieved from the media file play list.

Step B2: determining whether the compatible version number is more than a preset version number.

The preset version number refers to such a compatible version number that the preset version number is a boundary in reality, where there are different data formats of slice time lengths of compatible version numbers on both sides of the boundary. For example, the field #EXT-X-VERSION in the m3u8 file represents a compatible version number. In a particular implementation, the user can preset the preset version number dependent upon the file format applicable to the media play list under a real condition, so the embodiment of the invention will not be limited thereto.

Step B3: if so, determining the specified data format as a first data format corresponding to the version number.

Step B4, if not, determining the specified data format as a second data format corresponding to the version number.

In an embodiment, all the data formats of slice time lengths for compatible version numbers earlier than the preset version number in the m3u8 file are an integer number, and all the data formats of slice time lengths for the other compatible version numbers are a floating-point number, so in the embodiment of the invention, if the media play list is an m3u8 file, then the first data format may be an integer, and the second data format may be a floating-point number, so that it can be determined conveniently and rapidly whether the data format of the slice time length of the specified slice is the specified data format.

II. Process After it is Determined that the Slice Time Length is Abnormal.

In an embodiment, after the step 103 is performed (where it is determined that the slice time length of the specified slice is abnormal), after the step 103 in an embodiment of the invention, the method can further include: generating and transmitting abnormality information indicating that the slice time length of the specified slice is abnormal to a server generating the specified slice for outputting.

Thus the server generating the specified slice can have timely knowledge of the abnormality of the slice time length of the slice thereof, and display the abnormality information timely so that a human operator producing the slice can be informed, and correct the slice time length of the specified slice timely. In this way, the slice time length of the produced slice can be ensured to be accurate, and the media file corresponding to the slice can be played smoothly instead of being played abnormally.

In an embodiment, in order to correct conveniently the abnormal slice time length, in the embodiment of the invention, the abnormality information includes a slice time length error event and a corresponding handling suggestion including any one or more of:

If the preset condition includes lying within the preset range of time length, and the preset range of time length includes the largest slice time length, then a handling suggestion, corresponding to an error event indicating that the slice time length is more than the largest slice time length, is to correct the slice time length;

If the preset condition includes lying within the preset range of time length, and the preset range of time length includes the smallest slice time length, then a handling suggestion, corresponding to an error event indicating that the slice time length is less than the smallest slice time length, is to correct the slice time length;

If the preset condition includes lying within the preset range of time length, and the preset range of time length includes the smallest slice time length, and the empirical value of the shortest slice time length, then a handling suggestion, corresponding to an error event indicating that the slice time length is more than or equal to the smallest slice time length, and less than the empirical value of the shortest slice time length, is to re-confirm the slice time length; and

If the preset condition includes complying with the specified data format, then a handling suggestion, corresponding to an error event indicating that the slice time length does not comply with the specified data format, is to correct the slice time length.

The correcting the slice time length refers to that an error in the slice time length is determined, and needs to be corrected; and re-confirming the slice time length refers to that the slice time length may be correct, and needs to be re-confirmed. For example, further to the example above, the empirical value of the slice time length is 1 s (but not all the slice time lengths less than 1 s are incorrect), and the smallest slice time length is 16 ms; and if the specified slice is more than 16 ms but less than 1 s, then this will indicate that there may be an error in the specified slice, and the specified slice needs to be re-confirmed.

Thus the abnormality information indicates that there is a particular problem in the specified slice, and makes the reasonable handling suggestion so that the slice time length can be subsequently corrected timely.

An example illustrating the abnormality information in one of the combinations will be described, but the same principle will apply to the other combinations. For example, the preset condition is that the slice time length lies in the range from 1 s to 100 s, and the slice time length complies with the specified data format; and if the slice time length of the specified slice is 50 s, but t does not comply with the specified data format, then a corresponding handling suggestion is to correct the slice time length.

In an embodiment, for the combined abnormality information, if there are different handling suggestions made for different error events, then the handling suggestion to correct the slice time length may dominate.

In an embodiment of the invention, after the step 103, abnormality information can be generated and output without being transmitted to a server generating the specified slice.

In the embodiments above, the output abnormality information may be any one or more of a display, an audio output, etc.

Of course, in an embodiment of the invention, after it is determined in the step 103 that the slice time length is abnormal, abnormality information may not be generated and output, but instead the specified slice for which it is determined that the slice time length thereof is abnormal (or a slice identifier thereof) can be stored centrally in a specified storage space so that the user can determine those slices with incorrect slice time lengths.

In summary, in the embodiments of the invention, the slice time length is detected for abnormality so that the user has knowledge of whether the slice time length in the media file is correct, and thus can take the corresponding countermeasure to correct the abnormal slice time length so as to improve the correctness of the slice time length of the slice being produced, thus lowering the probability that the media file may be played abnormally.

### Second Embodiment

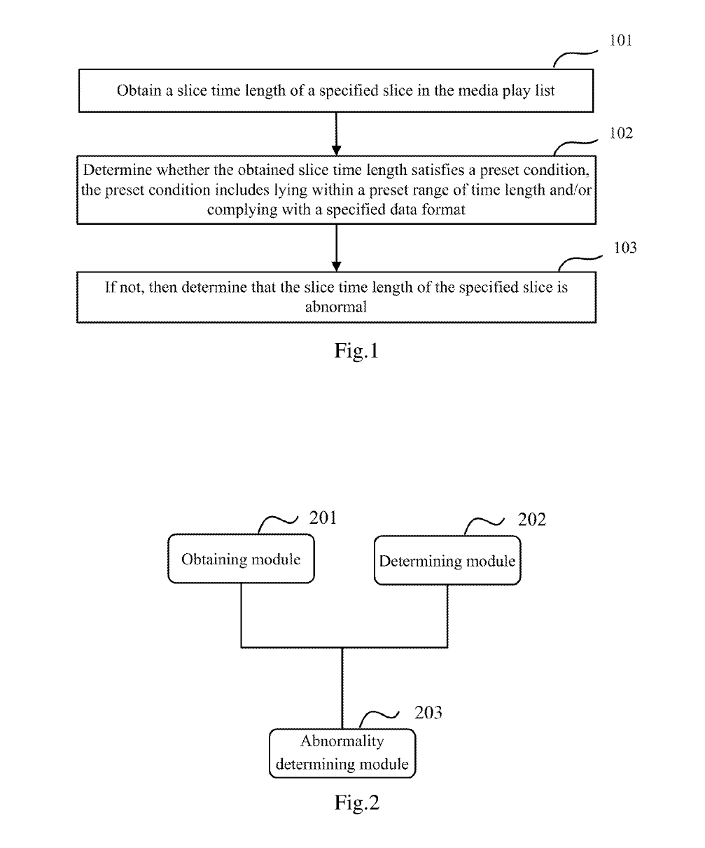

Based upon the same inventive idea, an embodiment of the invention further provides an device for detecting a slice time length in a media play list, and as illustrated in FIG. 2, there is a schematic structural diagram of the device including:

An obtaining module 201 is configured to obtain a slice time length of a specified slice in the media play list;

A determining module 202 is configured to determine whether the obtained slice time length satisfies a preset condition, the preset condition includes lying within a preset range of time length and/or complying with a specified data format; and

An abnormality determining module 203 is configured to determine that the slice time length of the specified slice is abnormal, if a result of the determination by the determining module is negative.

In the device for detecting a slice time length in a media play list according to the embodiment of the invention, the slice time length is detected for abnormality so that the user has knowledge of whether the slice time length in the media file is correct, and thus can take the corresponding countermeasure to correct the abnormal slice time length so as to improve the correctness of the slice time length of the slice being produced, thus lowering the probability that the media file may be played abnormally.

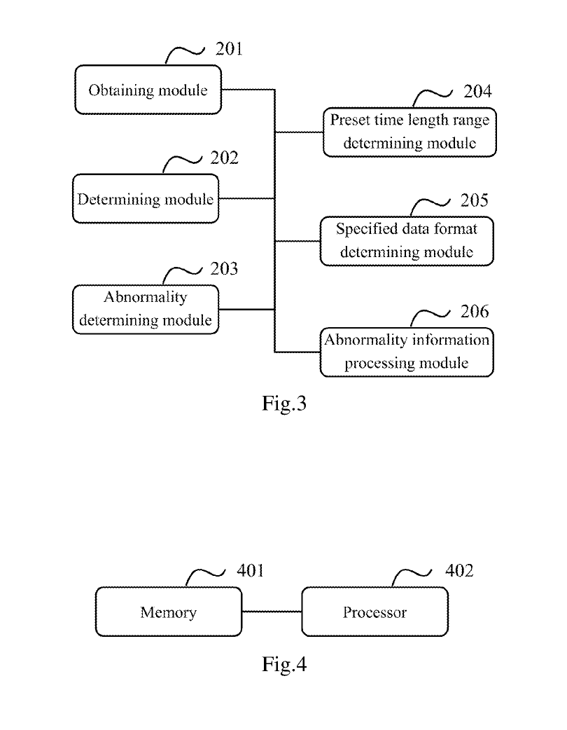

In an embodiment, as illustrated in FIG. 3, the device further includes:

A preset time length range determining module 204 configured to determine the preset range of time is configured:

To obtain at least one of reference values of range of time length including the largest slice time length, the smallest slice time length, and the empirical value of the shortest slice time length recorded in the media play list, where the empirical value of the shortest slice time length is less than the largest slice time length and more than the smallest slice time length; and

To determine the preset range of time length as a function of the reference value of the range of time length.

Thus the preset range of time length can be determined as a function of the reference value of the range of time length to thereby determine reasonably the preset range of time length under a real condition so that the determined preset range of time length is more applicable.

In an embodiment, as illustrated in FIG. 3, the device further includes:

A specified data format determining module 205 configured to determine the specified data format is configured:

To obtain a compatible version number of the media file play list;

To determine whether the compatible version number is more than a preset version number; and

If so, to determine the specified data format as a first data format corresponding to the version number, and

If not, to determine the specified data format as a second data format corresponding to the version number.

In an embodiment, if the media play list is an m3u8 file, then the first data format is be an integer, and the second data format is a floating-point number.

For example, all the data formats of slice time lengths for compatible version numbers earlier than the preset version number in the m3u8 file are an integer number, and all the data formats of slice time lengths for the other compatible version numbers are a floating-point number, so in the embodiment of the invention, if the media play list is an m3u8 file, then the first data format may be an integer, and the second data format may be a floating-point number, so that it can be determined conveniently and rapidly whether the data format of the slice time length of the specified slice is the specified data format.

In an embodiment, as illustrated in FIG. 3, the device further includes:

An abnormality information processing module 206 is configured to generate and transmit abnormality information indicating that the slice time length of the specified slice is abnormal to a server generating the specified slice for outputting, after the abnormality determining module determines that the slice time length of the specified slice is abnormal.

Thus the server generating the specified slice can have timely knowledge of the abnormality of the slice time length of the slice thereof, and display the abnormality information timely so that a human operator producing the slice can be informed, and correct the slice time length of the specified slice timely. In this way, the slice time length of the produced slice can be ensured to be accurate, and the media file corresponding to the slice can be played smoothly instead of being played abnormally.

In an embodiment, the abnormality information includes a slice time length error event and a corresponding handling suggestion including any one or more of:

If the preset condition includes lying within the preset range of time length, and the preset range of time length includes the largest slice time length then a handling suggestion, corresponding to an error event indicating that the slice time length is more than the largest slice time length, is to correct the slice time length;

If the preset condition includes lying within the preset range of time length, and the preset range of time length includes the smallest slice time length, then a handling suggestion, corresponding to an error event indicating that the slice time length is less than the smallest slice time length, is to correct the slice time length;

If the preset condition includes lying within the preset range of time length, and the preset range of time length includes the smallest slice time length, and the empirical value of the shortest slice time length, then a handling suggestion, corresponding to an error event indicating that the slice time length is more than or equal to the smallest slice time length, and less than empirical value of the shortest slice time length, is to re-confirm the slice time length; and

If the preset condition includes complying with the specified data format, then a handling suggestion, corresponding to an error event indicating that the slice time length does not comply with the specified data format, is to correct the slice time length.

Thus the abnormality information indicates that there is a particular problem in the specified slice, and makes the reasonable handling suggestion so that the slice time length can be subsequently corrected timely.

In summary, in the embodiments of the invention, the slice time length is detected for abnormality so that the user has knowledge of whether the slice time length in the media file is correct, and thus can take the corresponding countermeasure to correct the abnormal slice time length so as to improve the correctness of the slice time length of the slice being produced, thus lowering the probability that the media file may be played abnormally.

### Third Embodiment

Based upon the same inventive idea, an embodiment of the invention further provides a device for detecting a slice time length in a media play list, and as illustrated in FIG. 4, there is a schematic structural diagram of the device including:

A memory 401 is configured to store various program and instructions;

A processor 402 is configured to execute the various program and instructions stored in the memory to perform the operations of:

Obtaining a slice time length of a specified slice in the media play list; determining whether the obtained slice time length satisfies a preset condition, the preset condition includes lying within a preset range of time length and/or complying with a specified data format; and if not, then determining that the slice time length of the specified slice is abnormal.

Thus the slice time length is detected for abnormality so that the user has knowledge of whether the slice time length in the media file is correct, and thus can take the corresponding countermeasure to correct the abnormal slice time length so as to improve the correctness of the slice time length of the slice being produced, thus lowering the probability that the media file may be played abnormally.

In an embodiment, the processor configured to determine the preset range of time length is configured: to obtain at least one of reference values of range of time length including the largest slice time length, the smallest slice time length, and the empirical value of the shortest slice time length recorded in the media play list, where the empirical value of the shortest slice time length is less than the largest slice time length and more than the smallest slice time length; and to determine the preset range of time length as a function of the reference value of the range of time length.

Thus the preset range of time length can be determined as a function of the reference value of the range of time length to thereby determine reasonably the preset range of time length under a real condition so that the determined preset range of time length is more applicable.

In an embodiment, the processor configured to determine the specified data format is configured:

To obtain a compatible version number of the media file play list;

To determine whether the compatible version number is more than a preset version number; and

If so, to determine the specified data format as a first data format corresponding to the version number, and

If not, to determine the specified data format as a second data format corresponding to the version number.

In an embodiment, if the media play list is an m3u8 file, then the first data format may be an integer, and the second data format may be a floating-point number.

For example, all the data formats of slice time lengths for compatible version numbers earlier than the preset version number in the m3u8 file are an integer number, and all the data formats of slice time lengths for the other compatible version numbers are a floating-point number, so in the embodiment of the invention, if the media play list is an m3u8 file, then the first data format may be an integer, and the second data format may be a floating-point number, so that it can be determined conveniently and rapidly whether the data format of the slice time length of the specified slice is the specified data format.

In an embodiment, the processor is further configured to generate and transmit abnormality information indicating that the slice time length of the specified slice is abnormal to a server generating the specified slice for outputting, upon determining that the slice time length of the specified slice is abnormal.

Thus the server generating the specified slice can have timely knowledge of the abnormality of the slice time length of the slice thereof, and display the abnormality information timely so that a human operator producing the slice can be informed, and correct the slice time length of the specified slice timely. In this way, the slice time length of the produced slice can be ensured to be accurate, and the media file corresponding to the slice can be played smoothly instead of being played abnormally.

In an embodiment, the abnormality information includes a slice time length error event and a corresponding handling suggestion including any one or more of:

If the preset condition includes lying within the preset range of time length, and the preset range of time length includes the largest slice time length, then a handling suggestion, corresponding to an error event indicating that the slice time length is more than the largest slice time length, to correct the slice time length;

If the preset condition includes lying within the preset range of time length, and the preset range of time length includes the smallest slice time length, then a handling suggestion, corresponding to an error event indicating that the slice time length is less than the smallest slice time length, is to correct the slice time length;

If the preset condition includes lying within the preset range of time length, and the preset range of time length includes the smallest slice time length, and the empirical value of the shortest slice time length, then a handling suggestion, corresponding to an error event indicating that the slice time length is more than or equal to the smallest slice time length, and less than the empirical value of the shortest slice time length, is to re-confirm the slice time length; and

If the preset condition includes complying with the specified data format, then a handling suggestion, corresponding to an error event indicating that the slice time length does not comply with the specified data format, is to correct the slice time length.

Thus the abnormality information indicates that there is a particular problem in the specified slice, and makes the reasonable handling suggestion so that the slice time length can be subsequently corrected timely.

Moreover an embodiment of the invention further provides a computer program including computer readable codes that, when executed on a device, cause the device to perform the method for detecting a slice time length in a media play list according to any one of the embodiments above of the invention.

Moreover an embodiment of the invention further provides a computer readable medium storing the computer program.

In summary, in the device for detecting a slice time length in a media play list according to the embodiments of the invention, the slice time length is detected for abnormality so that the user has knowledge of whether the slice time length in the media file is correct, and thus can take the corresponding countermeasure to correct the abnormal slice time length so as to improve the correctness of the slice time length of the slice being produced, thus lowering the probability that the media file may be played abnormally.

The electronic device according to some embodiments of the disclosure can be in multiple forms, which include but not limit to:

1. Mobile communication device, of which characteristic has mobile communication function, and briefly acts to provide voice and data communication. These terminals include smart phone (i.e. iPhone), multimedia mobile phone, feature phone, cheap phone and etc.

2. Ultra mobile personal computing device, which belongs to personal computer, and has function of calculation and process, and has mobile networking function in general. These terminals include PDA, MID, UMPC (Ultra Mobile Personal Computer) and etc.

3. Portable entertainment equipment, which can display and play multimedia contents. These equipments include audio player, video player (e.g. iPod), handheld game player, electronic book, hobby robot and portable vehicle navigation device.

4. Server, which provides computing services, and includes processor, hard disk, memory, system bus and etc. The framework of the server is similar to the framework of universal computer, however, there is a higher requirement for processing capacity, stability, reliability, safety, expandability, manageability and etc due to supply of high reliability services.

5. Other electronic devices having data interaction function.

The embodiments of the device described above are merely exemplary, where the units described as separate components may or may not be physically separate, and the components illustrated as elements may or may not be physical units, that is, they can be collocated or can be distributed onto a number of network elements. A part or all of the modules can be selected as needed in reality for the purpose of the solution according to the embodiments of the disclosure.

Those skilled in the art can clearly appreciate from the foregoing description of the embodiments that the embodiments of the disclosure can be implemented in hardware or in software plus a necessary general hardware platform. Based upon such understanding, the technical solutions above essentially or their parts contributing to the prior art can be embodied in the form of a computer software product which can be stored in a computer readable storage medium, e.g., an ROM/RAM, a magnetic disk, an optical disk, etc., and which includes several instructions to cause a computer device (e.g., a personal computer, a server, a network device, etc.) to perform the method according to the respective embodiments of the disclosure.

Lastly it shall be noted that the embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the disclosure as claimed.

What is claimed is:

1. A method for detecting a slice time length in a media play list, comprising:
at an electronic device:
obtaining a slice time length of a specified slice in the media play list;
determining whether the obtained slice time length satisfies a preset condition, the preset condition comprises lying within a preset range of a time length and/or complying with a specified data format; and
if not, then determining that the slice time length of the specified slice is abnormal.

2. The method according to claim 1, wherein determining the preset range of the time length comprises:
obtaining at least one of the reference values of range of time length comprising a largest slice time length, a smallest slice time length, and an empirical value of a shortest slice time length recorded in the media play list, wherein the empirical value of the shortest slice time length is less than the largest slice time length and more than the smallest slice time length; and
determining the preset range of time length as a function of the reference value of the range of time length.

3. The method according to claim 1, wherein determining the specified data format comprises:
obtaining a compatible version number of the media file play list;
determining whether the compatible version number is more than a preset version number; and
if so, then determining the specified data format as a first data format corresponding to the version number, and
If not, then determining the specified data format as a second data format corresponding to the version number.

4. The method according to claim 3, wherein:
if the media play list is an m3u8 file, then the first data format is an integer, and the second data format is a floating-point number.

5. The method according to claim 1, wherein after determining that the slice time length of the specified slice is abnormal, the method further comprises:
generating and transmitting abnormality information indicating that the slice time length of the specified slice is abnormal to a server generating the specified slice for outputting

6. The method according to claim 5, wherein the abnormality information comprises a slice time length error event and a corresponding handling suggestion comprising any one or more of:
if the preset condition comprises lying within the preset range of time length, and the preset range of time length comprises the largest slice time length, then a handling suggestion, corresponding to an error event indicating that the slice time length is more than the largest slice time length, is to correct the slice time length;
if the preset condition comprises lying within the preset range of time length, and the preset range of time length comprises the smallest slice time length, then a handling suggestion, corresponding to an error event indicating that the slice time length is less than the smallest slice time length, is to correct the slice time length;
if the preset condition comprises lying within the preset range of time length, and the preset range of time length comprises the smallest slice time length, and the empirical value of the shortest slice time length, then a handling suggestion, corresponding to an error event indicating that the slice time length is more than or equal to the smallest slice time length and less than the empirical value of the shortest slice time length, is to re-confirm the slice time length; and
if the preset condition comprises complying with the specified data format, then a handling suggestion, corresponding to an error event indicating that the slice time length does not comply with the specified data format, is to correct the slice time length.

7. An electronic device, comprising:
at least one processor; and
a memory communicably connected with the at least one processor for storing instructions executable by the at least one processor, wherein execution of the instructions by the at least one processor causes the at least one processor to:obtain a slice time length of a specified slice in the media play list; determine whether the obtained slice time length satisfies a preset condition, the preset condition comprises lying within a preset range of time length and/or complying with a specified data format; and if not, then determining that the slice time length of the specified slice is abnormal.

8. The device according to claim 7, wherein the processor configured to determine the preset range of time length is configured: to obtain at least one of reference values of range of time comprising a largest slice time length, a smallest slice time length, and an empirical value of a shortest slice time length recorded in the media play list, wherein the empirical value of the shortest slice time length is less than the largest slice time length and more than the smallest slice time length; and to determine the preset range of time length as a function of the reference value of the range of time length.

9. The device according to claim 6, wherein the processor configured to determine the specified data format is configured to:
obtain a compatible version number of the media file play list;
determine whether the compatible version number is more than a preset version number; and
if so, determine the specified data format as a first data format corresponding to the version number, and
if not, determine the specified data format as a second data format corresponding to the version number.

10. The device according to claim 9, wherein if the media play list is an m3u8 file, then the first data format is an integer, and the second data format is a floating-point number.

11. The device according to claim 7, wherein the processor is further configured to generate and transmit abnormality information indicating that the slice time length of the specified slice is abnormal to a server generating the specified slice for outputting, upon determining that the slice time length of the specified slice is abnormal.

12. The device according to claim 11, wherein the abnormality information comprises a slice time length error event and a corresponding handling suggestion comprising any one or more of:
if the preset condition comprises lying within the preset range of time length, and the preset range of time length comprises the largest slice time length, then a handling suggestion, corresponding to an error event indicating that the slice time length is more than the largest slice time length, is to correct the slice time length;
if the preset condition comprises lying within the preset range of time length, and the preset range of time length comprises the smallest slice time length, then a handling suggestion, corresponding to an error event indicating that the slice time length is less than the smallest slice time length, is to correct the slice time length;
if the preset condition comprises lying within the preset range of time length, and the preset range of time length comprises the largest slice time length, and the empirical value of the shortest slice time length, then a handling suggestion, corresponding to an error event indicating that the slice time length is more than or equal to the smallest slice time length, and less than the empirical value of the shortest slice time length, is to re-confirm of the slice time length; and
if the preset condition comprises complying with the specified data format, then a handling suggestion, corresponding to an error event indicating that the slice time length does not comply with the specified data format, is to correct the slice time length.

13. A non-transitory computer-readable storage medium storing executable instructions that, when executed by an electronic device with a touch-sensitive display, cause the electronic device to::
obtain a slice time length of a specified slice in the media play list;
determine whether the obtained slice time length satisfies a preset condition, the preset condition comprises lying within a preset range of a time length and/or complying with a specified data format; and
if not, then determine that the slice time length of the specified slice is abnormal.

14. The storage medium according to claim 13, wherein determining the preset range of the time length comprises:
obtaining at least one of the reference values of range of time length comprising a largest slice time length, a smallest slice time length, and an empirical value of a shortest slice time length recorded in the media play list, wherein the empirical value of the shortest slice time length is less than the largest slice time length and more than the smallest slice time length; and
determining the preset range of time length as a function of the reference value of the range of time length.

15. The computer program according to claim 13, wherein determining the specified data format comprises:
obtaining a compatible version number of the media file play list;
determining whether the compatible version number is more than a preset version number; and
if so, then determining the specified data format as a first data format corresponding to the version number, and
If not, then determining the specified data format as a second data format corresponding to the version number.

16. The computer program according to claim 15, wherein:
if the media play list is an m3u8 file, then the first data format is an integer, and the second data format is a floating-point number.

17. The computer program according to claim 13, wherein the computer readable codes cause the device further to perform:
generating and transmitting abnormality information indicating that the slice time length of the specified slice is abnormal to a server generating the specified slice for outputting

18. The computer program according to claim 17, wherein the abnormality information comprises a slice time length error event and a corresponding handling suggestion comprising any one or more of:
if the preset condition comprises lying within the preset range of time length, and the preset range of time length comprises the largest slice time length, then a handling suggestion, corresponding to an error event indicating that the slice time length is more than the largest slice time length, is to correct the slice time length;
if the preset condition comprises lying within the preset range of time length, and the preset range of time length comprises the smallest slice time length, then a handling suggestion, corresponding to an error event indicating that the slice time length is less than the smallest slice time length, is to correct the slice time length;
if the preset condition comprises lying within the preset range of time length, and the preset range of time length comprises the smallest slice time length, and the empirical value of the shortest slice time length, then a handling suggestion, corresponding to an error event indicating that the slice time length is more than or equal to the smallest slice time length and less than the empirical value of the shortest slice time length, is to re-confirm the slice time length; and
if the preset condition comprises complying with the specified data format, then a handling suggestion, corresponding to an error event indicating that the slice time length does not comply with the specified data format, is to correct the slice time length.
